(19) United States
(12) Patent Application Publication
(10) Pub. No.: US 2006/0190155 A1
(43) Pub. Date: Aug. 24, 2006

(54) Device for controlling an engine or a gearbox

(76) Inventors: Werner Meyer, Fellbach (DE); Bernd-Heinrich Schmitfranz, Esslingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/531,583

(22) PCT Filed: Sep. 19, 2003
(86) PCT No.: PCT/EP03/10459

§ 371 Date: Nov. 16, 2005

(30) Foreign Application Priority Data
Oct. 19, 2002 (DE) 102 48 843.6

(51) Int. Cl. G06F 17/00

(52) U.S. Cl. 701/54; 701/51

(57) ABSTRACT

An arrangement for controlling a vehicle engine or transmission includes a control device arranged remotely from the engine/transmission (which provides the open-loop and closed-loop control algorithms), and a unit which is attached to the engine/transmission, and which is electrically connected directly to a plurality of sensors and/or actuators. The unit has an A/D converter for converting sensor signals into digital sensor signals, which are then converted into data bus signals by a data bus transceiver unit, for communication via a data bus between the unit and the control device. A uniform sensor/actuator interface is provided, with a plurality of parallel connections for the sensors/actuators and a connection for the data bus. A signal converter converts the sensor signals directly into the data bus signals in accordance with an open-loop/closed-loop control algorithm without the intermediate connection of a calculating means.

This application claims the priority of German patent document 102 48 843.6, filed Oct. 19, 2002 (PCT International Application No. PCT/EP2003/010459, filed Sep. 19, 2003), the disclosure of which is expressly incorporated by reference herein.

The invention relates to a device for controlling a vehicle engine or transmission, having a control device arranged remotely from the engine/transmission, which provides open-loop and closed-loop control algorithms, and a unit which is attached to the engine/transmission, and is electrically connected directly to a plurality of sensors. The unit has an A/D converter for converting the sensor signals originating from the sensors into digital sensor signals, which in turn are converted to data bus signals by a data bus transceiver unit, for communication via a data bus, between the unit and the remotely situated control device.

European patent document EP 0 758 726 A2 and German patent document DE 100 36 601 A1 each disclose a controller for a motor vehicle having an automatic transmission. The control device with the open-loop/closed-loop control algorithm for the transmission is attached to the transmission as an add-on unit. Sensors and actuators inside the transmission are connected to the control device via a plug. Since the control device is installed on the transmission, it must be both heat-resistant and protected against soiling, which requires an increased level of complexity. In addition, during manufacture and assembly, it is necessary to provide a matching control device for the transmission. For a different transmission for the same motor vehicle in which more sensors are used, it is necessary to install a control device with modified hardware terms. As a result, whenever changes are made to the transmission the control device hardware must also be changed.

German patent document DE 199 63 610 A1 discloses a data bus system with control devices for motor vehicles, in which each control device is divided into an operations control function and an I/O processing function. Each function is assigned a separate microcontroller, and one operations control function and one I/O processing function form together one control device. In a vehicle with transmission variants, it is therefore necessary for the control device to be matched each time to the other transmission variant, which leads to a high level of expenditure.

German patent document DE 199 48 969 A1 discloses a control apparatus for a vehicle drive train composed of an engine and transmission. A first control device is situated remotely from the transmission, while a second transmission control device is provided on the transmission itself. Electronic components with a high power loss (in particular output stages) are installed in the transmission control device, which must be heat-resistant, because it is attached to the transmission. Both control devices have at least one microcomputer, memory and output stages for actuating sensors and actuators. The microcomputer runs software for implementing open-loop and closed-loop control algorithms and carries out sensor signal conditioning. Since the sensors and actuators must be arranged directly on the transmission control device, only a small number of assemblies or vehicle variants is covered with one version of the control device. For vehicles with different engine types and series, this means that a control device with different interfaces for sensors must be developed in each case for gasoline or diesel variants or different numbers of cylinders. In addition, a new control device must be developed to increase the computing power and to carry out additional functionalities for the conventional control device concepts.

When control devices are installed on the drive train (for example on the engine or on the transmission), the temperature load for the electronic components provided there (in particular for the increasingly complex microcomputers and memories) is very high, and entails additional costs for the qualification of the components for the assembly-specific ambient temperatures. On the other hand, if the respective control devices are arranged remotely from the assemblies (for example the transmission), an extensive amount of cabling has heretofore been necessary between the assemblies and control devices in order to connect the sensors and actuators.

in European patent document EP 0388107 B1, a data bus has a plurality of control devices, one of which controls the engine of a vehicle. The data bus interconnects the various control devices, and a controller of the throttle valve is connected to the data bus. The throttle valve controller is connected to the throttle valve actuator motor which is installed in the region of the motor. In another embodiment, knocking sensors are installed on the cylinders, while the control device is also arranged remotely from the engine in said embodiment. In both embodiments the sensors and actuators are installed directly on the engine and connected directly to the control device.

One object of the present invention is to provide a device for controlling an engine/transmission with a control device which is situated remotely from the engine/transmission, in which expenditures for cabling for the sensors and actuators on the assembly are reduced.

A further object of the present invention is to provide an electronic connection of the sensors and actuators on the control device in such a way that only a small number of control device variants is necessary for the various drive train variants with the different sensors and actuators.

These and other objects and advantages are achieved by the control arrangement according to the invention, in which a plurality of control devices are each configured with a uniform data bus transceiver unit that is connected to an assembly data bus. Each such unit comprises an assembly-specific sensor/actuator interface with a plurality of parallel connections for the sensors/actuators and a connection for the assembly data bus. A signal converter is provided for converting the sensor signals of a plurality of sensors into the data bus signal so that it is possible to use the same control device without changing the hardware of its sensor/actuator connection, even for designs of the device with different assembly variants with different sensors/actuators. The signal converter also converts the sensor signals directly into the data bus signals in accordance with an open-loop/closed-loop control algorithm without the intermediate connection of a calculation, and the sensor/actuator interface is designed for production vehicles with a plurality of engine/transmission variants in at least two designs, with said designs differing in the number of sensor connections provided.

The assembly data bus, which may be of electrical or optical design, has a capability for serial data transmission in digital form with real-time-specific peripheral conditions, and permits synchronous data transmission of the sensor signals. The assembly-specific sensor/actuator interfaces are connected to the assembly data bus. In addition, the assembly data bus is connected to a standardized data bus transceiver unit of the control devices.

In addition to the assembly data bus it is possible to arrange a further vehicle data bus between the control devices, routed in the passenger compartment of the vehicle. Messages are exchanged directly between the control devices via the vehicle data bus, and signals are transmitted by assemblies which are arranged remotely from the assembly to be controlled. For example, signals are transmitted from the exhaust gas sensor system, fuel tank venting system and the like to the engine control device, processed there in a control algorithm, and transmitted via the assembly data bus to the sensor actuator interface in the motor and/or transmission. In this context, “Data bus” is understood to mean a medium which can transmit digital signals. Conventional binary high signals or low signals or even pulse-width modulated signals can be sent via data bus here.

The control devices are of standardized design, so that a plurality of control devices have the same interface for the assembly data bus. The internal design of the control device may be standardized with respect to microcomputers, memories and housings, so that open-loop and closed-loop control algorithms can be performed by application software, while the control devices have matching hardware. This results in a considerable cost advantage when complex systems are built up.

The control device which is arranged remotely from the assembly (i.e., engine and/or transmission) comprises in each case a powerful microcomputer and a corresponding software which may be composed of individual software modules. Each alternative transmission or engine type is then assigned a matching software module. After the software has been input into the control device, the software carries out the open-loop/closed-loop control algorithms for the engine/transmission unit. The control device which is arranged remotely from the assembly is electrically connected to the sensor/actuator interface via a data bus line. The data bus signals are decomposed by the signal converter in the control device and in the sensor/actuator interface, and the individual components are assigned to the various sensors and actuators. In addition, the individual signals are converted in the sensor/actuator interface so that they can both control the actuators arranged in the transmission or engine as analog signals, and the sensor signals are also digitized in the opposite direction and converted into the data bus signal, so that they can be processed further in the control device which is arranged remotely.

In one embodiment of the invention, the unit comprises an assembly-specific sensor/actuator interface with a plurality of parallel connections for the sensors/actuators and a connection for the assembly data bus; and a signal converter is provided for converting the sensor signals of a plurality of sensors into the data bus signal, so that for embodiments of the device for different assembly variants with different sensors/actuators it is possible to use the same control device without hardware modification of its sensor/actuator connection. A control device is integrated into the housing of the gear selector lever for shifting gear speeds or for shifting an automatic transmission.

In another embodiment of the invention, a plurality of standard control devices are provided, each being independent of assemblies and each having standardized interfaces with the sensor/actuator interface and with the rest of the surroundings of the vehicle. In this context, the assembly-specific aspects are moved to the sensor/actuator interface. Aspects which are independent of the assemblies are assigned to the standardized assembly control device. The sensor/actuator interface and the assembly control device are connected to one another via a standardized interface (i.e., via the data bus transceiver unit). The assembly-specific sensor/actuator interface preferably provides a means for converting and preparing signals, in particular closed-loop control, near to the actuators, as well as, for example, basic engine functions for providing emergency functions.

Connections for sensors such as the engine speed, crankshaft speed or temperature of the transmission and connections for actuators such as injection valves, ignition coils and switching valves are provided at the sensor/actuator interface. Pedal value signal transmitters, a charger probe, an exhaust gas temperature sensor and connections for actuators such as clutch switches, starter relays, fuel pumps or fuel tank venting valves are connected either directly to a control device or connected via a sensor/actuator interface to a vehicle data bus. The assembly-specific sensors and actuators are connected to the sensor/actuator interface. With respect to the engine, it is also possible to provide sensors such as a knocking sensor, a crankshaft/camshaft rotation speed sensor, an air mass flowmeter and actuators such as throttle valves, swirl valves and exhaust gas valves, ignition coils and injection valves. The sensor/actuator interface is arranged directly on the assembly (i.e., on the transmission or on the engine). The sensors are provided on the outside or inside of the assembly.

The sensor/actuator interface is, as it were, a distributor between the various sensors and actuators; it converts the sensed signals into data bus signals so that they can be transmitted via the data bus sequentially (i.e., using a time-division multiplex method), or in parallel (with a frequency-division multiplex method). Apart from the sensing of signals and the operation of actuators, the sensor/actuator interface can also preprocess signals and store adaptation parameters. However, the sensor/actuator interface does not carry out any open-loop/closed-loop control algorithm calculations: instead, it merely transmits the sensor and actuator signals via the assembly data bus to the control device which is arranged remotely where the complex open-loop control algorithms are then carried out.

A major advantage of the present invention is that only the sensor/actuator interface needs be adapted for different assembly variants, for example gasoline or diesel engines with different numbers of cylinders, different transmissions with different gear speeds and differing clutches. The remotely arranged control device can remain essentially unchanged in terms of its hardware, while all that is necessary is to input other software modules into the control device.

When there are a greater number of sensors, a sensor/actuator interface with a greater number of connections is then provided, with the data bus protocol remaining unchanged so that only a greater number of messages are transmitted via the assembly data bus. As a result, one standard control device can be provided for a predefined number of assembly variants. In the field of motor vehicle manufacture or aircraft manufacture, this leads to the considerable advantage that it is unnecessary to produce a new control device for each assembly variant. Only the sensor/actuator interface (as it were, the adapter or multiple plug) for the sensors and actuators is changed. The complex microcomputers with closed-loop and open-loop control algorithms are not provided in the sensor/actuator interface, and thus, do not need to be adapted with a high degree of expenditure.

As a result of the separation of the control device as a closed-loop and open-loop control unit and the sensor/actuator interface for the assembly-specific sensor system and actuator system, it is possible for the control device, with the highly integrated semiconductors such as microcomputers and memories, to be located in the vehicle at an installation location which is less environmentally stressed, for example in the footwell of the front seat passenger. As a result, with the highly integrated semiconductors there are cost and quality advantages over the current solution where a control device with microcomputer is installed directly on the assembly.

The sensor/actuator interface can be configured easily, in terms of cost and quality criteria, for the rough operating conditions in the engine compartment and on the assembly. The sensor/actuator interface can be embodied with a small number of printed circuit board layers, simpler ceramic substrates (such as thick-film ceramic, Al₂O₃ and less complex modules) than is the case with the control devices used on the assembly in the past. The less complex sensor/actuator interface permits the dissipated heat to be conducted away better (in particular, from the power semiconductors), and permits higher operating temperatures; it also provides improved robustness with respect to environmental influences. Furthermore, a small number of sensors and actuators can already be integrated in the sensor/actuator interface. As a result of the greater robustness of the sensor/actuator interface in comparison with a control unit, more free spaces are obtained when locating the sensors and actuators on the assembly itself. The sensor/actuator interface can therefore be used for optimized placement with respect to the assembly cable set.

The sensor/actuator interface has a storage means in which the digital sensor signals can be buffered and where the sensor signals are converted in terms of the predefined value range and/or standardization of the signals to a predefined numerical range. The data bus transceiver unit reads out the digital sensor signals from the storage means, and converts them into data bus signals which can then be transmitted to the control device via the assembly data bus. The conversion into data bus signals at the sensor/actuator interface can be carried out, for example, into the known data bus protocols, such as CAN, LIN, Firewire, Bluetooth, USB, pulse width modulation, and other modulated signals such as frequency modulation or amplitude modulation. In order to convert the signals into the predefined value range, and to diagnose whether the sensor or actuator carries out its functions, it is possible to provide a very small robust microcomputer, so that when the control device fails or when there are interface problems the safety and availability of the sensor and actuator signal transmission is then ensured, for example, by means of an emergency transmission path. However, the sensor/actuator interface also differs from the control devices provided in the fitting solution in that no open-loop and closed-loop control algorithms are provided for the sensors and actuators. A pure hardware solution can be provided for a particularly fast conversion of the sensor signals into data bus signals.

In one particularly preferred development of the sensor/actuator interface for production vehicles such as ships, aircraft and motor vehicles, there are at least two embodiments of each type, each differing in the number of sensor/actuator connections provided. In certain production vehicles it is not necessary for all the connections of the sensor/actuator interface to be assigned; instead the sensor/actuator interface is configured in such a way that it can be used even when certain connections are not assigned. As a result a very small number of variants of the sensor/actuator interface and of the associated control devices is produced even though there can be a large number of different assembly variants. It is then not necessary to provide new connections for new sensors and actuators on the control device every time; instead only one data bus connection to the sensor/actuator interface needs be provided. The number of variants ultimately affects the data bus messages to be transmitted. The individual sensor signals are usually transmitted sequentially by means of an asynchronous or synchronous data bus protocol to the control device and evaluated there in their chronological sequence. The closed-loop control algorithms are then applied by the control device and the control signals for the actuators are transmitted again via the assembly data bus to the sensor/actuator interface, and converted there in such a way that the actuators can be actuated.

It is also possible to switch a plurality of sensor/actuator interfaces in parallel or in cascades so that one sensor/actuator interface can be arranged on the engine and one sensor/actuator interface can be arranged on the transmission. The control device can then have, for example, two data bus connections which are connected in an electrically conductive fashion to the different sensor/actuator interfaces.

In another development of the invention, the transmission control device is integrated into the housing of the automatic transmission or gear speed selector lever of the means of transportation. If appropriate, the entire transmission control system including a sensor/actuator interface can be integrated into the selector lever. This makes sense in particular in rear-wheel drive vehicles because of the direct proximity of the transmission and gear selector lever.

The control apparatus can also be arranged in conjunction with assemblies such as clutches, starter generators or drives in the field of utility vehicle engineering, marine engineering or aircraft engineering. In addition, according to the present invention the sensor/actuator interface can also be used in hybrid vehicles or hydrogen-powered vehicles.

A further advantage of the present invention is that a diagnosis or test phase (for example during the manufacture of vehicles) is simplified. Instead of connecting the sensor/actuator interface to the control device, it can be connected directly to a diagnostic device or test device which models the control device in various test phases. In particular, workshop and test bench computers may be connected on the production line to the sensor/actuator interfaces or to the assembly data bus. Alternatively, what is referred to as a hardware-in-the-loop method can be carried out. The sensor/actuator interface permits simple connection of the test devices which then make available the necessary test signals for the test operation. For example a test operation for the sensors and actuators is then simulated without the vehicle control device being connected. The control device and the sensor/actuator interface can be supplied by different manufacturers, so that it is possible to break the connection between the sensor and actuator connection and the supplier of the control device, which in turn permits a modular concept that simplifies the use of replacement parts.

According to the invention a test method is also provided for the device at the end of the line of the assembly production. Here, the assembly control device (for example engine control or transmission control device) is replaced by a powerful test bench computer and complex tests are carried out at short time intervals, which tests cannot be performed by an assembly control device, due to its limited computing power and limited storage space. The test method can thus be integrated into the line run intervals. Furthermore, the line end test program in the assembly control device can be dispensed with and the program storage requirement thus reduced. Only the test programs for the onboard or running time diagnostics need be present in the assembly control device.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a combined engine and transmission controller with two sensor/actuator interfaces according to the invention and two control devices which are each arranged remotely from the assembly; and

FIG. 2 shows a further embodiment of the device according to the invention.

### DETAILED DESCRIPTION OF THE DRAWINGS

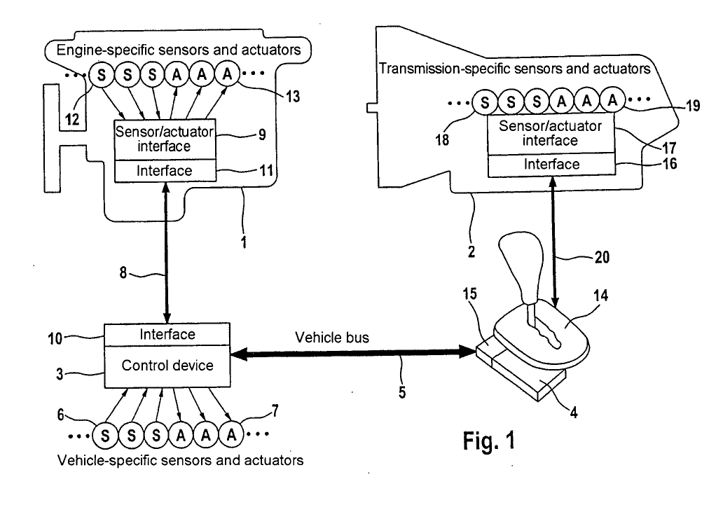

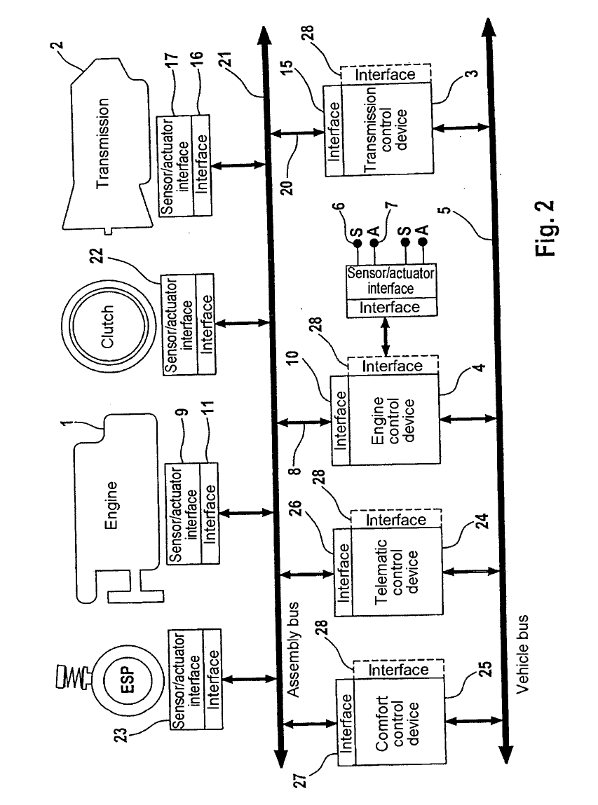

As shown in FIGS. 1 and 2, the device for controlling an engine 1 and a transmission 2 has, in each case, an engine control device 3 and transmission control device 4 which are arranged remotely from the engine and transmission. The control devices 3, 4 each provide open-loop and closed-loop control algorithms for the respective assembly. The engine control device 3 is electrically connected to the transmission control device 4 via a vehicle data bus 5 (for example a CAN vehicle bus). Messages, which may relate, for example, to information from vehicle-specific sensors 6 or control signals of the control devices 3, 4 for the actuators 7, are exchanged via the vehicle data bus 5.

The engine control device 3 is connected via an assembly data bus 8 to the sensor/actuator interface 9 which is attached to the engine 1. Both the engine control device 3 and the sensor/actuator interface 9 have a data bus transceiver unit as interfaces 10, 11, by which data bus signals are transmitted bidirectionally from the sensor/actuator interface 9 to the engine control device 3 and vice versa.

The digital data bus signals are stored in the sensor/actuator interface 9, and each is assigned to a respective engine-mounted sensor 12 or engine-mounted actuator 13. The digital data stored in the storage means of the sensor/actuator interface 9 is then subjected, as necessary, to digital/analog conversion and transmitted to the sensors 12 and actuators 13 at and in the engine 1. The sensor/actuator interface 9 only converts the signals of the sensors and actuators 12, 13 into the data bus signals for the assembly data bus 8, and these converted signals of the engine-specific sensors 12 and actuators 13 are then correspondingly converted in the engine control device 3 so that the signals can be processed in the open-loop and closed-loop control algorithm of the engine control device 3 in order to operate the engine 1 at the desired power level or with a desired function.

The transmission control device 4 is situated remotely from the transmission 2, at the automatic selector lever 14 or at a gear speed shift means arranged in the passenger compartment of the vehicle. It may be arranged, for this purpose, within an encapsulated housing which surrounds the electronics and mechanical components of the automatic selector lever 14; alternatively, it can be arranged in the vicinity of the automatic selector lever 14. Control signals of the transmission control device 4 are converted into the data bus signals, and back again into digital signals, in a data bus transceiver unit 15 and in a data bus transceiver unit 16 of the sensor/actuator interface 17. The digital signals are stored in the storage means of the sensor/actuator interface 17 and, where appropriate, converted back again, by means of D/A converters, into signals which can be transmitted via the various connections of the sensor/actuator interface 17 to the transmission-specific sensors 18 and the transmission/specific actuators 19.

The sensor/actuator interface 9 or 17 converts the sensor and actuator signals into the corresponding data bus signals for the assembly data bus 8, 20 and, if appropriate, the value ranges are checked and the signal values are standardized to a specific sensor value range. The actual open-loop and closed-loop control calculations are carried out in the control devices 3, 4.

The vehicle-specific sensors and actuators 6, 7 may be, for example, operator controls for the engine and transmission; but they can also be telematic functions which have, in whatever form, an influence on the engine and transmission controllers. The calculation functions which are related to the preselection by means of the operator controls are then implemented in the control devices 3, 4 and the complex microelectronics are thus removed from the respective assembly 1, 2. The control devices may be arranged outside the engine compartment (for example in the passenger compartment of the vehicle), since the expenditure in terms of cabling for sensors and actuators is also very low. The assembly data bus 8 and 20 may have not only the signal lines for the sensor signals but also a power or voltage supply line, in order to supply the individual sensors and actuators with current. However, the actuators can also be supplied with current independently of the assembly data bus 8, 20.

The transmission controller for the different types of transmission, automated gearshift mechanism, converter transmission or CVT differ primarily with respect to the sensors and actuators. The actual control function for all the transmissions is carried out by means of software modules, with the possibility of each transmission being assigned a specific module and the software being compiled from individual library functions for each transmission. As a result of the invention's arrangement of sensor/actuator interfaces 9, 17 it is also possible to retain the control device hardware in different engine/transmission variants and only the less complex sensor/actuator interface 9, 17 which is embodied as an integrated semiconductor component is replaced.

In another embodiment of the invention according to FIG. 2, an assembly data bus 21 which is separate from the vehicle data bus 5 connects a plurality of sensor/actuator interfaces 9, 17, 22, 23 to one another. This permits a uniform exchange of information between the sensor/actuator interfaces 9, 17, 22, 23 and all the assembly control devices 3, 4, 24, 25. This has the advantage that, for example, the transmission control device 3 can directly access the raw value of the engine speed from the sensor/actuator interface 9 on the engine 1 and evaluate, resolve or filter the signal according to transmission-specific requirements. The gateway functionality for such signals (i.e., the expenditure on passing on signals from the assembly data bus 21 to the vehicle data bus 5) is significantly reduced in the assembly control devices 3, 4, 24, 25.

Since all the assembly control devices 3, 4, 24, 25 can then communicate with all the sensor/actuator interfaces 9, 17, 22, 23, if one assembly control device 3, 4, 24, 25 fails, the basic functionality can be assumed by another assembly control device 3, 4, 24, 25, for example. If the transmission control device 3 fails, the engine control device 4 can make available a basic gearshift program. This means that the arrangement according to the invention results in a control device structure which can be used for redundancy purposes. If redundancy is also necessary at the sensor/actuator interface 9, 17, 22, 23, the expenditure on the sensor/actuator interface 9, 17, 22, 23 is limited; i.e., it is not necessary for the entire transmission electronics to be configured with redundancy.

FIG. 2 shows an embodiment of the invention, which includes an assembly data bus 21 that connects the individual sensor/actuator interfaces 9, 17, 22, 23 to one another. The assembly data bus 21 is also connected to a plurality of standardized control devices 3, 4, 24, 25 whose hardware is essentially the same, and whose differences in terms of their functionality are implemented by means of the closed-loop and open-loop control software. The control devices 3, 4, 24, 25 are each connected via a uniform data bus transceiver unit 10, 15, 26, 27 to the assembly data bus 21. As has previously been customary in motor vehicles, the control devices 3, 4, 24, 25 are interconnected to one another via the vehicle data bus 5. Each control device 3, 4, 24, 25 can also have an interface 28 where sensors and actuators can be connected directly to the control device 3, 4, 24, 25. This interface 28 is used for sensors/actuators 6, 7 which are arranged near to the control device 3, 4, 24, 25 and are necessary for each assembly variant so that the interface 28 may be provided in a standardized fashion on all motor vehicle variants.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-6. (canceled)

7. An arrangement for controlling vehicle drive train assemblies having a control device which is arranged remotely from the drive train assembly and which performs the open-loop and closed-loop control algorithms, and a unit which is attached to the drive train assembly, is electrically connected directly to a plurality of sensors, and has an A/D converter for converting analog sensor signals originating from the sensors into digital sensor signals which are then converted into data bus signals by means of a signal converter and fed into a data bus via a data bus transceiver unit for communication via the data bus between the unit and the control device; wherein:
a plurality of control devices are interconnected to one another via a first data bus and are each provided with a uniform data bus transceiver unit to which an assembly data bus is also connected;
the unit comprises an assembly-specific sensor/actuator interface with a plurality of parallel connections for the sensors and a connection for the assembly data bus;
a signal converter is provided for converting the digital sensor signals of a plurality of sensors into the data bus signal, whereby the same control device can be used for different assembly variants with different sensors, without hardware modification of its sensor connection;
the signal converter converts the sensor signals directly into the data bus signals without intermediate connection of a calculating means corresponding to an open-loop/closed-loop control algorithm; and
the sensor/actuator interface accommodates series traffic transmission with a plurality of drive train assembly variants in at least two embodiments which differ in the number of sensor connections provided.

8. The arrangement as claimed in claim 7, wherein:
additional actuators can be connected to the sensor/actuator interface;
the control data which are input via the assembly data bus for the actuator or actuators, are converted into digital control data for the individual actuator, so that the actuators can be actuated via the assigned sensor/actuator connections.

9. The arrangement as claimed in claim 7, wherein the sensor/actuator interface checks the sensor signals relative to a predefined value range, or a standardization of the signals relative to a predefined numerical range.

10. The arrangement as claimed in claim 8, wherein:
the sensor/actuator interface has storage means for buffering digital sensor signals; and
the data bus transceiver unit reads out digital sensor signals from the storage means and converts them into data bus signals.

11. The arrangement as claimed in claim 10, wherein a single data bus protocol is provided for use with a plurality of different embodiments of the device having a different number of sensors/actuators compared to the control device.

12. The arrangement as claimed in claim 11, wherein a portion of the sensor/actuator connections of the sensor/actuator interface are unassigned.
